(19) United States
(12) Patent Application Publication
(10) Pub. No.: US 2011/0177258 A1
(43) Pub. Date: Jul. 21, 2011

(54) METHOD AND DEVICE FOR WIPING LIQUID COATING METAL AT THE OUTLET OF A TEMPERING METAL COATING TANK

(75) Inventors: Roland Ernst, Gieres (FR); Yves Fautrelle, Meylan (FR); Benjamin Grenier, Saint-Paul-En-Jarez (FR); Jean-Jacques Hardy, Irigny (FR)

(73) Assignees: SIEMENS VAI METALS TECHNOLOGIES SAS, SAINT-CHAMOND (FR); L'INSTITUT POLYTECHNIQUE DE GRENOBLE, GRENOBLE CEDEX (FR)

(21) Appl. No.: 13/120,524

(22) PCT Filed: Sep. 23, 2008
(86) PCT No.: PCT/FR08/01322

§ 371 Date: Mar. 23, 2011

(51) Int. Cl. B05D 3/00; H01F 1/00

(52) U.S. Cl. 427/547; 335/219

(57) ABSTRACT

A method and device disclose how to drain a liquid coating metal from the two sides of a running steel strip. The method transfers a strip coated with a liquid coating metal, as it runs at the tank outlet, from a region not subjected to a magnetic field to another region subjected to a static magnetic field generated between the poles of magnetic members arranged opposite each other on either side of the strip and having field lines, or at least a main shell of the field lines, intersecting with the strip over at least one minimum longitudinal extent so that the liquid coating metal is correlatively subjected to a magnetic field variation generating on the liquid metal a force opposite to the running direction. Due to the low field variation, this magnetic braking effect generates little Foucault current in the strip.

This invention relates to a method and device for wiping liquid coating metal at the outlet of a tempering metal coating tank according to the preamble of claims 1 and 12.

The invention relates to the wiping of a liquid metal film in the form of a liquid metal coating applied by tempering to a steel strip in a continuous coating line.

“Liquid metal film” means any type of coating applicable to steel strips, for example zinc- and aluminum-based alloys.

In order to improve their resistance to corrosion in certain applications such as building, automotive and domestic appliances, a metal coating such as zinc or a zinc-based alloy is laid onto the surface of the steel strips. This coating is effected on continuous lines that typically comprise:
An entry section with one or two strip uncoilers, a guillotine shear, a butt welder for connecting the tail of a strip coming out of one of the uncoilers to the head of a following strip coming out of the other uncoiler and thus ensuring the continuous operation of the line, a strip accumulator, which returns to the line the strip previously accumulated while uncoiling upstream of the accumulator is interrupted to effect a butt weld.
A degreasing section for cold-rolled strips or an acid-pickling section for hot-rolled strips.
An annealing furnace that also keeps the strip at a controlled temperature before it enters the liquid metal bath.
An actual coating section with the liquid metal bath into which the strip is immersed, a liquid metal wiping device, possibly an induction alloying furnace, a cooling system and a tempering tank.
An outlet section with a skin-pass mill, a passivation device, an outlet accumulator, a shear and one or two recoilers.

In a first variant of the method, at its outlet from the furnace, the steel strip is immersed obliquely in a liquid metal alloying bath, it is diverted vertically by a roller immersed in the bath, then it passes over an “anti-cupping” roller intended to correct its transverse curvature caused by passing over the bottom roller, then over a “pass line” roller intended to adjust its vertical trajectory. In a second variant of the method, at its outlet from the furnace, the steel strip is diverted vertically by a roller and then crosses vertically through a liquid metal alloying bath sustained magnetically.

In both cases, at its outlet from the coating bath, the strip is covered, on both faces, with a liquid metal film whose thickness is the result of a balance established between the driving forces of the liquid by the strip and the forces of gravity. The thickness of the liquid coating metal must be balanced transversely and longitudinally to a value as close as possible to the target value which combines performance research in the field of corrosion protection and optimization of the quantity of metal used. To achieve this, devices are arranged on either side of the strip in order to ensure the wiping of the liquid film on both faces.

Such wiping systems have been amply described, for example in document EP 0 566 497. The principle of wiping consists of blowing a jet of gas in order to produce a necking effect in the liquid film intended to reduce its thickness, the surplus film wiped returning by gravity to the coating tank. The distance between the strip and such wipers as well as the gas pressure and the distance between the wipers and the surface of the coating bath and the speed of movement of the strip are among the essential variables governing wiping. These variables are controlled on the basis of measurements taken by coating thickness measuring instruments arranged on both faces of the strip, for example x-ray gauges.

It has long been known in relation to the limitations of the gas jet wiping method that, at high strip movement speeds, a phenomenon known as “splashing” occurs. This phenomenon, related to the thickness of the driven liquid film which increases with the movement speed, is caused by a loss of equilibrium between the driving forces of the strip, gravity and a surface tension in a zone of the film where shear stresses are generated by the gas jet. This results in a release of droplets that disturb the gas jet, adversely affect the quality of the coating and are most often followed by a bursting of the intended film. The strip movement speed, and therefore the productivity of the coating line, is also limited by the liquid film wiping capacity.

Numerous attempts have been made to prevent this phenomenon and to enable higher strip movement speeds. These include in particular magnetic systems designed to wipe the strip of a part of the liquid coating film, complemented, downstream, by a final gas-jet wiping.

Several families of methods using magnetic induction are therefore known, all of these families being based on the creation of (Lorentz) forces within the liquid conducting medium under the combined effect of a current and a magnetic field:
“Longitudinal flux” methods that implement an induction coil that surrounds the strip and is powered using alternating current. This type of device generates field lines approximately parallel to the “longitudinal” movement of said strip inducing an alternating current in the metal coating film and the strip. The interaction between the current thus induced and the magnetic field causes the development of radial and axial electromagnetic forces that wipe the film. By way of example, document JP 5051719 describes such a longitudinal field system powered with high-frequency alternating current.
“Transverse flux” methods that implement two separate induction coils powered with alternating current, each placed on one of the two sides of the strip. This type of device generates magnetic field lines approximately perpendicular to the longitudinal running movement of said strip inducing Foucault currents in the plane of the strip. The interaction between these currents and the magnetic field generates a development of electromagnetic shear forces that wipe the liquid metal film. By way of example, documents DE 2023900 and JP 08134617 describe such transverse field systems powered with alternating current at the appropriate frequency.
“Travelling field” methods that implement, on each side of the strip, multi-pole stators powered with polyphase alternating current. This type of device generates a magnetic field travelling in a direction opposite to a running movement of the upward-moving strip, thus creating a downward pumping action of the liquid film. By way of example, documents U.S. Pat. No. 3,518 109 and JP 08053742 describe such a travelling field system powered with polyphase alternating current.
The “meniscus pressure” method which implements a stator at the level of a connecting meniscus of the liquid film driven by the strip with the liquid bath. A magnetic field acts on the curve of the meniscus and therefore on the thickness of the driven film. By way of example, document EP 1 138 799 describes such a meniscus-control system. This method remains very difficult to implement and is limited to the metal coating of small objects such as wire.
As an alternative to some of the methods described above, permanent magnets have also been used that need to be combined with electrical strip power devices by applying sliding contacts or rollers to the strip, making these methods hardly appropriate for wiping. Examples of such methods are described in documents JP 61-227158 and JP 02-254147. Finally, also in the field of permanent magnets, JP 2000-212714 proposes mounting a plurality of magnets on a rotating drum in order to create a variable magnetic field in order to create induction effects usable in wiping.

Each of these methods has a certain number of drawbacks that considerably complicate their implementation. These drawbacks may be classified as follows:
Heating of the strip: All longitudinal and transverse flux systems generated by induction coils powered with alternating current cause considerable heating of the strip up to temperatures of over 100° C. In particular longitudinal fluxes that, with identical wiping effect, require higher powers, may result, in certain configurations, in temperature increases up to 150 to 200° C. This heating is such as to disturb a combination steel/coating layer encouraging unwanted phenomena of iron diffusion to the coating.

Moreover, this additional heat must then be dissipated in a cooling tower, which results in an increase of its height and/or an increase in the power of air blowing installations.
Saturation of the strip: Magnetic saturation of the strip is quite quickly achieved in a space generated by magnetic field lines and, once the strip is saturated, it becomes itself a limitation to wiping capacity and therefore strip movement speed. This risk is particularly prevalent in longitudinal flux or even transverse flux methods.
Strip marking: Electrical strip power methods using sliding contacts or rollers cannot be used for quality galvanized strips, as they leave mechanical friction marks on the strip.

One object of the present invention is in particular to ensure an effective wiping of the liquid coating metal at the outlet of a tempering metal coating tank for a steel strip moving longitudinally, wherein the limiting effects of magnetic strip saturation are minimized.

The invention is also intended to:
minimize strip heating;
prevent mechanical marking of the strip/film;
use magnetic wiping without any “splashing” effects;
enable precise control of the intended coating thickness.

The invention therefore presents a method and a device designed to resolve these problems according to the content of claims 1 and 12.

On the basis of a method for wiping liquid coating metal at the outlet of a tempering metal coating tank for both faces of a steel strip in continuous longitudinal movement, the invention then provides that during movement out of the tank, the strip covered with liquid coating metal passes through a region not subjected to a magnetic field to another region subjected to a static magnetic field created between the poles of magnetic members arranged facing one another on either side of the strip and whose field lines, or at least a main shell of said field lines, intersect over at least one minimum longitudinal extent with said strip, so that the liquid coating metal is correlatively subjected to a magnetic field variation generating on said liquid metal a force opposite to the running direction thereof with the strip. In fact, said longitudinal extent of intersection is selected to be as small as possible while sufficient to generate in the liquid metal film Foucault currents of minimal intensity but whose circulation in the static magnetic field is sufficient to generate the Lorentz forces necessary to adequately resist the movement of said liquid metal in relation to the strip.

The running movement of the strip in this static magnetic field may thus induce a current in the strip, but also and above all in the liquid film where a magnetic deceleration effect opposing running movement of the strip develops, in a known manner.

On account of the low field variation this magnetic deceleration effect generates few Foucault currents in the strip. The continuous nature of the magnetic field, by the absence of skin effect, limits the power dissipated to achieve an effective wiping effect of the liquid film and thus the heating of the strip is very advantageously insignificant.

No contact with the strip is necessary, therefore marking issues are advantageously avoided. Using a magnetic field, in particular for the purpose of wiping in several successive stages by a succession of wiping devices, avoids the drawback due to “splashing” effects.

In order to implement the method described according to the invention, an embodiment of a device is possible on the basis of a device for wiping liquid metal at the outlet of a tempering metal coating tank for both faces of a steel strip (1) in continuous longitudinal movement. At the tank outlet, the device provides that:
at least a first magnetic member is placed transversely to a first of the two faces of the strip at a given distance from the strip, and that a second magnetic member is placed transversely to a second of the two faces of the strip, approximately at the same distance from said strip,
the poles of said magnetic members (A1, A2) are distributed facing one another on each side of the strip such as to generate between said poles static magnetic field lines (included in a main shell) intersecting over at least one minimum longitudinal extent with the strip.

A set of dependent claims also sets out the advantages of the invention.

Examples of embodiments and applications are provided using the figures described:

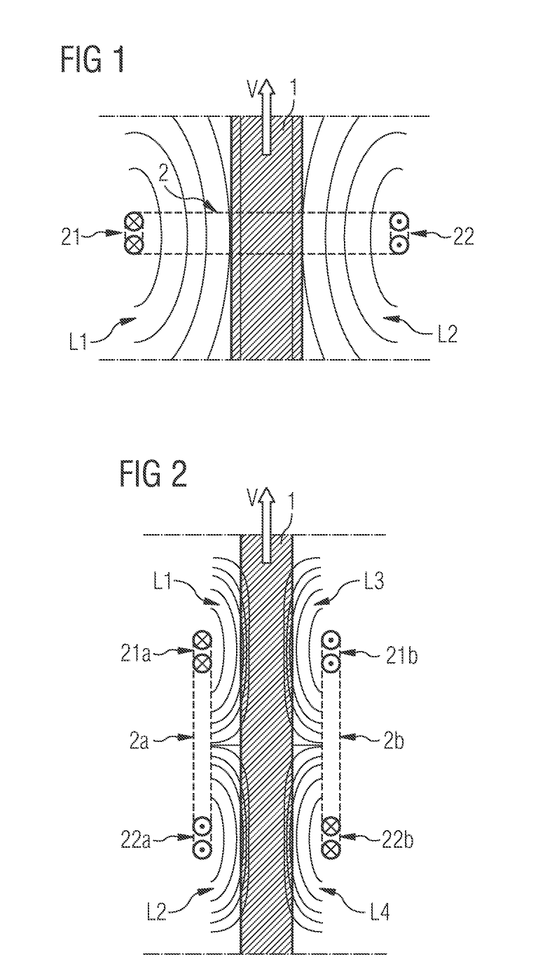

FIG. 1 Wiping device by “longitudinal flux”,

FIG. 2 Wiping device by “transverse flux”,

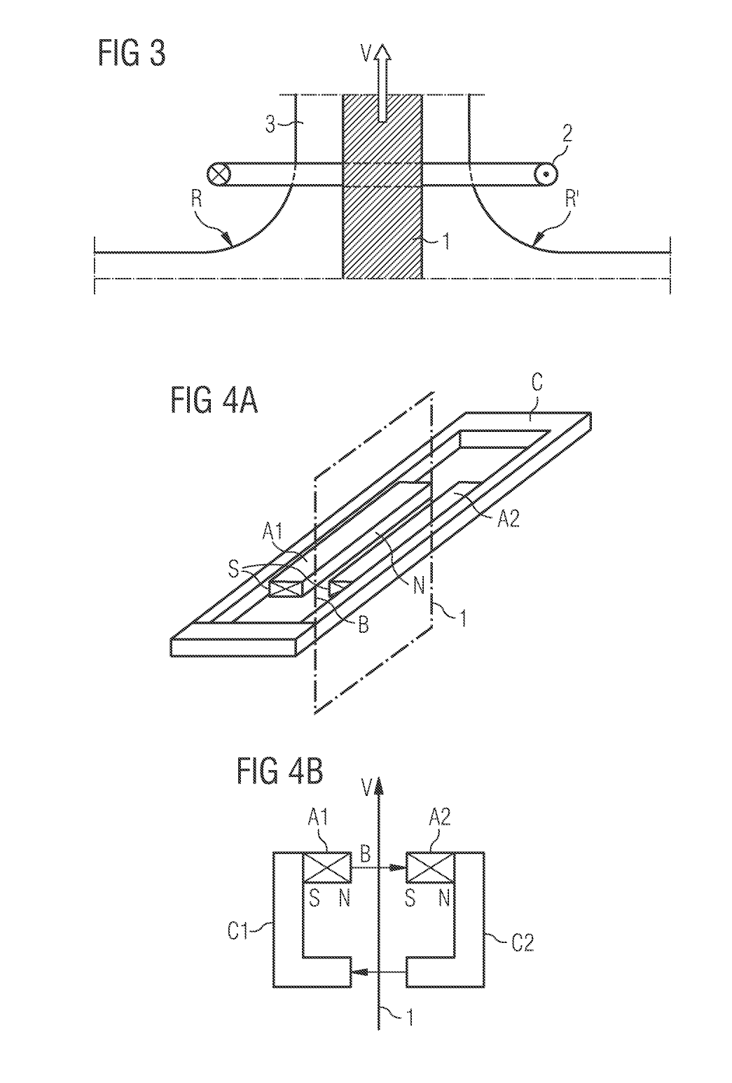

FIG. 3 “Meniscus pressure” wiping device,

FIGS. 4a, 4b Wiping device with magnetic members according to a first embodiment of the invention,

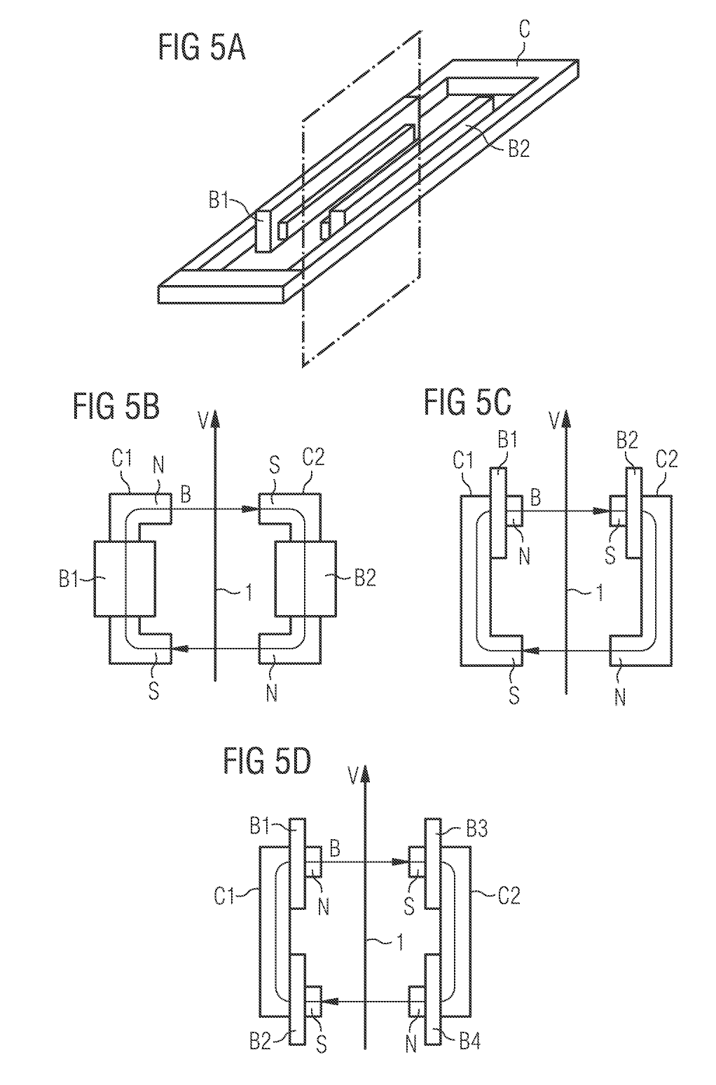

FIGS. 5a, 5b, 5c, 5d Wiping device with electromagnetic members according to a second embodiment of the invention,

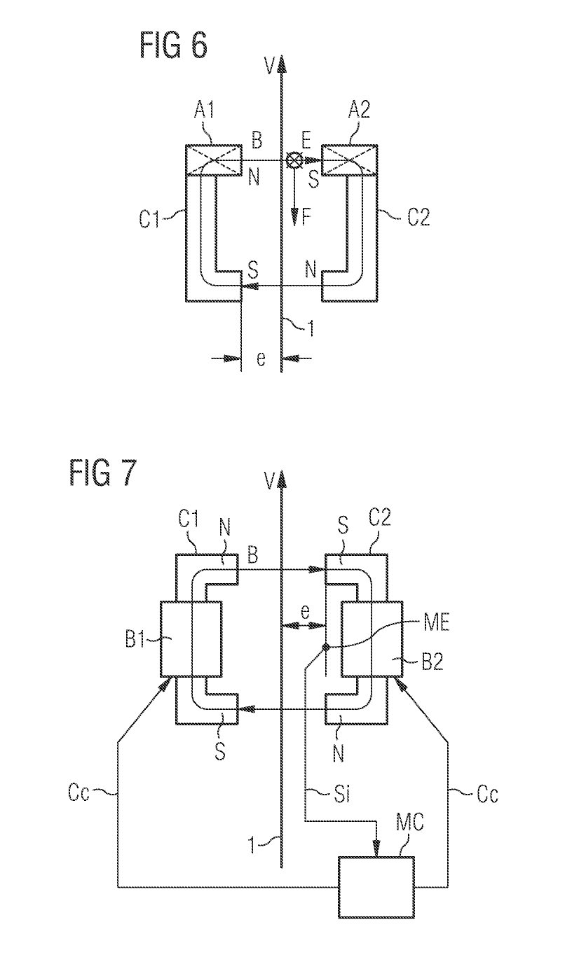

FIG. 6 Wiping principle according to the first embodiment of the invention,

FIG. 7 Wiping principle with distance stabilization control according to the second embodiment of the invention.

FIG. 1 shows a wiping device of a metal coating film of the faces of a steel strip (1) in continuous vertical longitudinal movement by “longitudinal flux” as described above in the prior art. The strip (1) is thus covered on both of its faces with a liquid film (not shown) and is driven by a vertical movement of speed (V). An induction coil (2) comprising one or more turns of an electric conductor surrounding the strip widthways is crossed by an alternating current at a frequency appropriate for induction generating the wiping effect. FIG. 1 shows the path of the current according to one of its alternations. This current generates an alternating magnetic field that manifests itself, on either side of the strip, as two lobes (L1) and (L2) respectively associated with two ends (21, 22) of the coil, shown in section. In the immediate vicinity of the strip, the field lines are generated and have a route parallel to its direction of movement, hence the name “longitudinal flux”. They do not cross the strip, but extend over a wide longitudinal portion of it.

FIG. 2 shows a wiping device of a metal coating film of the faces of a steel strip (1) in continuous vertical longitudinal movement by “transverse flux” as described above in the prior art. The strip (1) is thus covered on both of its faces with a liquid film (not shown) and is driven by a longitudinal vertical movement of speed (V). Two induction coils (2a, 2b), each arranged symmetrically facing the other on one side of the strip in the direction of its width, are crossed by an alternating current at a frequency suitable for induction generating the wiping effect. FIG. 2 shows the path of the current according to one of its alternations. This current generates an alternating magnetic field that manifests itself, on either side of the strip, as four lobes (L1, L2, L3, L4) respectively associated to coil portions (21a, 22b, 21b, 22b). In the immediate vicinity of the strip, field lines are generated and have a path globally perpendicular to the direction of movement thereof and extend at least over the width sections of the strip, hence the name “transverse flux”. These field lines loop over the coil portion that generates them in a direction perpendicular to the running movement. They do not therefore cross the strip but extend along it at least transversely.

FIG. 3 shows a “meniscus pressure” wiping device designed for a liquid coating film. A strip (1) is thus covered with a liquid film (3) and is driven by a longitudinal vertical movement of speed (V).

An induction coil (2) comprising one or more turns of an electric conductor surrounding the strip widthways is crossed by an alternating current at a frequency appropriate to the wiping effect. FIG. 3 shows the path of the current according to one of its alternations. The magnetic field acts on the curve (R, R′)of the meniscus and therefore on the thickness of the driven film.

FIGS. 4a, 4b show a wiping device with magnetic members according to a first embodiment of the invention, and more specifically a device designed to wipe liquid metal at the outlet of a tempering metal coating tank for both faces of a steel strip (1) in continuous longitudinal movement. At the outlet of this tank, the device comprises:
at least a first magnetic member (A1), such that here at least one permanent magnet, is placed transversely to a first of the two faces of the strip at a given distance from the strip, and that a second magnetic member (A2) is placed transversely to a second of the two faces of the strip, approximately at the same distance from said strip,
the poles (N, S), in this case North/South magnets, of said magnetic members (A1, A2) are distributed facing one another on each side of the strip such as to generate between said poles static magnetic field lines (B) included in a main shell intersecting over at least one minimum longitudinal extent with the strip as provided for in the invention.

In other words, the devices according to FIGS. 4a and 4b therefore provide for each magnetic member to comprise at least one bipolar permanent magnet member (A1, A2) whose magnetic capacity is set to induce at least one electromotive field able to generate in counter-interaction to the forced running movement of the strip in the static magnetic field (B) a wiping deceleration adapted to the layers of metal coating initially laid on the strip.

The closest poles of each magnetic member (A1, A2) are here of opposed magnetic polarity (N, S). Thus, it is possible to configure the field lines between these poles across the strip. The longitudinal extent is therefore reduced to approximately the height of one of the magnets used.

It would also be possible to provide for the poles of each magnetic member (A1, A2) closest to the strip to have the same magnetic polarity.

According to FIG. 4a, the poles (S, N) of each magnetic member (A1, A2) furthest away from the strip (external transverse faces of the permanent magnets) are also connected by an external magnetic field guide (C), such as a ferromagnetic frame yoke forming a magnetic guide loop around a section of the strip.

Therefore, according to FIG. 4a, the magnetic poles (N, S) closest to the two magnetic members facing one another on either side of the strip are arranged such that they generate a static magnetic field (B) that forms a magnetic circuit between the North pole (N) of the first magnetic member and the South pole (S) of the second crossing the strip, the magnetic loop being completed between the external poles, i.e. the North pole (N) of the second magnetic member and the South pole (S) of the first member through a ferromagnetic yoke (C) surrounding the strip.

Alternatively according to FIG. 4b, the wiping device provides that each magnetic member (A1, A2) comprises two distinct poles, successively arranged in the direction of running movement of the strip and connected to at least one magnet by a magnetic field guide (C1, C2) such as at least one ferromagnetic yoke portion forming a magnetic guide half-loop such that, between each of the two poles at the ends of the two half-loops, the half-loops are arranged facing one another on either side of the strip, therefore completely looping the magnetic field lines. In other words, two permanent magnets in a “U” shape are arranged symmetrically in relation to the strip by placing the bases of the two “U” shapes facing one another with opposing polarity on either side of the strip.

Thus, a first ferromagnetic yoke portion (C1) extends the South pole (S) of the first magnetic member (A1) and a second ferromagnetic yoke portion (C2) extends the North pole (N) of the second magnetic member (A2). The magnetic field (B) crosses the strip for the first time between the North pole (N) of the first magnetic member and the South pole (S) of the second magnetic member, then is channeled over the second ferromagnetic yoke portion (C2), then crosses the strip for a second time, the loop being completed in the first ferromagnetic yoke portion (C1).

It is recommended that at the extremities of the half-loops, the poles have opposing magnetic polarity so that the two half-loops induce a closed-loop magnetic guidance of the magnetic field (B) across the strip.

As described above, it would also be possible that at the extremities of the half-loops, the poles have identical magnetic polarity. Wiping will be possible, but less effective than with the opposed magnetic polarity configuration described above.

Not restrictively to FIGS. 4a, 4b and therefore also applicable to the figures below, each magnetic member is extended linearly in one or more blocks over a length at least equal to one strip width. Moreover, several magnetic members extended linearly over a length at least equal to one strip width may be distributed one above the other in the direction of running movement of the strip and on either side of it. By thus forming successive zones of field/strip intersection of minimum extent to prevent magnetic strip saturation, this configuration advantageously enables the efficiency of wiping to be increased. For the same purpose, at least one of the magnetic members may be linked to a complementary wiping device such as gas jets, or a complementary strip stabilization device.

FIGS. 5a, 5b show two configurations of a wiping device with electromagnetic members (as magnetic members) according to a second embodiment of the invention relating respectively to the configurations in FIGS. 4a, 4b.

In particular in FIG. 5a, the two electromagnetic members (B1, B2) are arranged transversely to the running movement of the strip on either side of the two faces of the strip and are connected by a ferromagnetic yoke (C) surrounding said strip.

FIGS. 5c, 5d show two other configurations of a wiping device with electromagnetic members (as magnetic members) according to this second embodiment of the invention.

In particular, FIGS. 5b, 5c and 5d show, according to a configuration of the ferromagnetic yoke in two half-loops (C1, C2) arranged transversely to the running movement of the strip on either side of the two faces of the strip, several possible arrangements of said electromagnetic members (B1, B2, B3, B4). In these examples, a magnetic field loop is created by two strip crossings by the magnetic field (B) and by complementary channeling of the magnetic field by means of ferromagnetic half-yokes, as shown in FIG. 4b.

The electromagnetic members (B1, B2, B3, B4) are here induction coils related to the yoke or yokes (C, C1, C2) in order to generate said static magnetic field and channel the field lines to the edges of the strip and in particular over a minimum extent of intersection with the strip. By adjusting the supply current of at least one of said induction coils, the intensity of the static magnetic field is controllable according to the parameters chosen for a wiping type.

In FIG. 5b, each of the two induction coils (B1, B2) is placed centrally on each half-yoke (C1, C2) in a “U” shape. In FIG. 5c, each of the two induction coils (B1, B2) is placed in the vicinity of one of the magnetic pole extremities (N, S) on each half-yoke (C1, C2) in a “U” shape, the extremities facing one another on either side of the strip. In FIG. 5d, each of the four induction coils (B1, B2, B3, B4) is placed on one of the four extremities of the two half-yolks in accordance with the model in FIG. 5b.

The closest poles of each electromagnetic member (B1, B2) are here of opposed magnetic polarity (N, S). Thus, it is possible to configure the field lines between these poles across the strip.

(FIGS. 5a-5d with “suitable polarity”)

It would also be possible to provide for the poles of each electromagnetic member (B1, B2) closest to the strip to have the same magnetic polarity. It is however more difficult in this configuration to minimize the extent of the intersection between the field lines and the strip. However, such a configuration enables the position of the strip between the poles to be controlled more easily by acting on the direct-current electricity supply of at least one of the two electromagnetic members. Thus, it may be advantageous to arrange each of these two configurations (opposing and identical magnetic polarity) successively in the direction of running movement for the purpose of wiping and stabilization of the strip. Wiping will be possible, but less effective than with the opposed magnetic polarity configuration described above.

FIG. 6 shows the wiping principle of a liquid metal coating film by magnetic deceleration according to the first embodiment of the invention (FIG. 4b). The strip (1) is covered on both of its faces with the liquid film (not shown) and is driven by a longitudinal vertical running movement of speed (V). Two magnetic members (A1, A2) and their yokes (C1, C2) whose shape is shown purely by way of example are each arranged widthways on one side of the strip and at a distance (e) from it. They are arranged such that the North pole (N) of one of the magnetic elements (A1, A2) is situated opposite the South pole (S) of the other magnetic member such that the magnetic field (B) loops in the two members crossing the strip (1) twice. The running movement of the strip in this static magnetic field (B) induces an electromotive field (E) between the poles of opposing polarity and therefore a current in the strip and the liquid film where a magnetic deceleration force (F) opposing the running movement of the strip develops.

FIG. 7 shows a magnetic-deceleration wiping principle with distance stabilization control (or strip centering) according to a second embodiment of the invention (FIG. 5b).

At least one of the magnetic members here comprises at least one electromagnetic member (B1, B2) (induction coil electromagnet) whose magnetic capacity can be adjusted by a command module (MC) via a control signal (Cc) ideally controlling at least one induction coil (B2) here encapsulating the field-guide electromagnetic member (C2), to:
induce at least one electromotive field (E) able to generate in counter-interaction to the forced running movement of the strip in the static magnetic field (B) a wiping deceleration adapted to the layers of metal coating initially laid on the strip,
advantageously set an equal distance between each magnetic member and the strip.

The command module (MC) is controlled by a processing unit able to receive at least one of the following two signals in order to adjust a current setting in the induction coil:
a distance measurement signal (Si) from a contactless measurement system (ME) of the distance (e) between the strip and one of the electromagnetic members (B1, B2),
a magnetic field measurement signal from a field measurement instrument (MB) to at least one electromagnetic member pole, said field measurement signal being correlatable with the distance values (e).
   As a function of this correlation, a command unit generates a current setting in the induction coil of at least one of the electromagnetic members such as to keep the steel strip in a defined position between the poles, able to ensure the best possible distribution of the coating on both faces of the strip.

In addition to the fact that use of electromagnets makes it possible to provide magnetic fields that are more intense than permanent magnets, it also makes precise control possible. In particular, it enables the strip to be kept dynamically in a given position between the two electromagnetic members.

All of the devices proposed in FIGS. 4, 5, 6 and 7 are therefore able to implement the wiping method according to the invention, i.e. a method for wiping liquid coating metal at the outlet of a tempering metal coating tank for both faces of a steel strip (1) in continuous longitudinal movement, wherein when moving out of the tank, the strip covered with liquid coating metal passes from a region not subjected to a magnetic field to another region subjected to a static magnetic field (B) created between the poles (N, S) of magnetic members (A1, A2, B1, B2) placed facing one another on either side of the strip and whose field lines intersect over at least one minimum longitudinal extent with said strip, so that the liquid coating metal is correlatively subjected to a magnetic field variation generating on said liquid metal a force opposite to the running direction thereof with the strip. The interaction of the static magnetic field and the moving strip generates Foucault currents in the strip and the liquid coating film whose circulation in the static magnetic field generates Lorentz forces that oppose the running movement of said liquid metal in relation to the strip, hence the magnetic deceleration effect in relation to the moving strip (forced).

This magnetic deceleration effect generates few Foucault currents in the strip and the continuous nature of the magnetic field, by the absence of skin effect, limits the power dissipated to achieve an effective wiping effect of the liquid film and thus the heating of the strip is very advantageously negligible.

As described above, the method ideally provides for the poles arranged closest on either side of the strip to ideally be of opposing polarity. This aspect helps to minimize the extent of intersection between the field lines with the strip and therefore advantageously makes it possible to avoid the effects of magnetic strip saturation and enables high wiping efficiency due to the significant magnetic field variations when passing beneath the poles. A configuration with close poles of identical polarity is also possible, but less effective for wiping of the desired type, however it presents the advantage of enabling better positional control of the strip between the poles by the action of the direct-current supply of the induction coils.

An intensity of the magnetic field (B) related to the desired wiping effect is simply controlled by varying a distance (e) between the poles and the strip, the poles being ideally those of permanent magnets in the context of simple stand-alone magnetic members.

he method may also advantageously provide that:
in at least one point in the field lines, a distance (e) is determined, ideally by direct contactless measurement, between the moving strip and at least one of the two electromagnetic members (B1, B2) (for example the electromagnets) fitted with induction coils as magnetically controllable magnetic members,
a direct-current power source of at least one of the induction coils is controlled in order to keep the strip centered between the two electromagnetic members.

A total magnetic flow crossing the strip (see examples in FIGS. 4 to 7) may thus be kept statically and fine tuned around its static value.

The direct-current power supply of at least one of the induction coils (B1, B2) is controlled in order to adjust the intensity of the magnetic field (B) related to the desired wiping effect. This is significant for adapting the method to different strip and/or coating types and also makes it possible to subject the wiping system to coating thickness measurement by a measurement instrument such as an x-ray thickness gauge.

The method also provides that:

A) in at least one point in the field lines, a distance (e) is determined between the moving strip and at least one of the two electromagnetic members (B1, B2) by measuring the magnetic field variations due to a variation initiated by the gap effect between the strip and at least one of the two electromagnetic members. A direct measurement of the distance (e) is also possible, as an alternative or complement to the indirect magnetic field measurement method above.

B)
at least two sets of magnetic members are distributed transversely across a width of a least one side of the strip,
and if the magnetic members are electromagnetic members fitted with induction coils, each power current of the induction coils is controlled separately. The positional control of the strip between the magnetic members is therefore effectively facilitated.

C)
at least two sets of magnetic members are distributed one above the other in the direction of running movement of the strip and on either side of it,
and if the magnetic members are electromagnetic members fitted with induction coils, each power current of the induction coils is controlled separately.

This succession of sets of magnetic or electromagnetic members makes it possible to effectively distribute the wiping effects and to control strip position.

The wiping method according to the invention may, if required, also be implemented and controlled in association with a complementary wiping method, such as gas jets on the strip faces. It may also be implemented and controlled in association with a complementary strip running movement stabilization method.

1-25. (canceled)

26. A method for wiping a liquid coating metal disposed on both faces of a steel strip via a continuous longitudinal movement at an outlet of a tempering metal coating tank, which comprises the steps of:
when moving out of the tempering metal coating tank, passing the steel strip covered with the liquid coating metal from a region not subjected to a magnetic field to another region subjected to a static magnetic field created between poles of magnetic members placed facing one another on either side of the steel strip and whose field lines intersect over at least one minimum longitudinal extent with the steel strip, so that the liquid coating metal is correlatively subjected to a magnetic field variation generating on the liquid coating metal a force opposite to a running direction of the steel strip.

27. The method according to claim 26, which further comprises forming the poles disposed closest on either side of the steel strip to having opposing polarities.

28. The method according to claim 26, which further comprises forming the poles disposed closest on either side of the steel strip to have identical polarities.

29. The method according to claim 26, which further comprises controlling an intensity of the static magnetic field related to a desired wiping effect by varying a distance between the poles and the steel strip, the poles being those of permanent magnets.

30. The method according to claim 26, which further comprises:
forming at least two of the magnetic members as electromagnetic members fitted with induction coils;
in at least one point in the field lines, estimating a distance between the moving steel strip and at least one of the two electromagnetic members fitted with the induction coils; and
controlling a direct-current power source of at least one of the induction coils in order to keep a position of the steel strip between the two electromagnetic members.

31. The method according to claim 30, which further comprises controlling the direct-current power source of at least one of the induction coils in order to adjust an intensity of the static magnetic field related to a desired wiping effect.

32. The method according to claim 30, which further comprises in at least one point in the field lines, determining the distance between the moving steel strip and at least one of the two electromagnetic members by measuring the magnetic field variations due to a variation initiated by a gap effect between the steel strip and at least one of the two electromagnetic members.

33. The method according to claim 26, which further comprises:
distributing at least two sets of the magnetic members transversely across a width of a least one side of the steel strip; and
if the magnetic members are electromagnetic members fitted with induction coils, controlling each power current of the induction coils separately.

34. The method according to claim 26, which further comprises:
distributing at least two sets of the magnetic members one above another in a direction of running movement of the steel strip and on either side of the steel strip; and
if the magnetic members are electromagnetic members fitted with induction coils, controlling each power current of the induction coils separately.

35. The method according to claim 26, which further comprises implementing and controlling the method in association with a complementary wiping method.

36. The method according to claim 26, which further comprises implementing and controlling the method in association with a complementary strip running movement stabilization method.

37. The method according to claim 30, which further comprises estimating the distance via a direct contactless measurement.

38. The method according to claim 35, which further comprises subjecting the metal strip to gas jets.

39. A device for wiping liquid coating metal disposed on two faces of a steel strip in a continuous longitudinal movement at an outlet of a tempering metal coating tank, the device comprising:
at least a first magnetic member disposed transversely to a first of the two faces of the steel strip and at a given distance from the steel strip;
a second magnetic member disposed transversely to a second of the two faces of the steel strip, approximately at a same distance from the metal strip as said first magnetic member; and
said first and second magnetic members having poles distributed facing one another on each side of the metal strip such as to generate between said poles static magnetic field lines, included in a main shell, intersecting over at least one minimum longitudinal extent with the steel strip.

40. The device according to claim 39, wherein said poles of each of said first and second magnetic members that are closest have opposing magnetic polarity.

41. The device according to claim 39, wherein said poles of each of said first and second magnetic members that are closest to the steel strip have a same magnetic polarity.

42. The device according to claim 40, further comprising an external magnetic field guide, said poles of each of said first and second magnetic members furthest away from the steel strip are connected by said external magnetic field guide.

43. The device according to claim 40,
further comprising magnetic field guides; and
wherein each of said first and second magnetic members has two distinct poles, successively disposed in a direction of a running movement of the steel strip and connected to at least one magnet by one of said magnetic field guides, said magnetic field guides each being at least one ferromagnetic yoke portion forming a magnetic guide half-loop such that, between each of said two poles at ends of said two magnetic guide half-loops, said magnetic guide half-loops disposed facing one another on either side of the steel strip.

44. The device according to claim 43, wherein at extremities of said magnetic guide half-loops, said poles have opposing magnetic polarity so that said two magnetic guide half-loops induce a closed-loop magnetic guidance of a magnetic field across the steel strip.

45. The device according to claim 43, wherein at extremities of said magnetic guide half-loops, said poles have identical magnetic polarity so that said two magnetic guide half-loops induce a half-closed-loop transverse magnetic guidance of a magnetic field transversally to the steel strip.

46. The device according to claim 39, wherein each of said first and second magnetic members is extended linearly in at least one block over a length at least equal to one strip width of the steel strip.

47. The device according to claim 46, wherein said first and second magnetic members extended linearly over a length at least equal to one strip width and are distributed one above another in a direction of running movement of the steel strip and on either side of the steel strip.

48. The device according to claim 39, further comprising a gas-jet wiping device and at least one of said first and second magnetic members is associated with said gas-jet wiping device.

49. The device according to claim 39, further comprising a complementary strip-stabilization device and at least one of said first and second magnetic members is associated with said complementary strip-stabilization device.

50. The device according to claim 39, wherein each of said first and second magnetic members has at least one bipolar permanent magnet member whose magnetic capacity is set such as to induce at least one electromotive field able to generate in counter-interaction to a forced running movement of the steel strip in a static magnetic field a wiping deceleration adapted to layers of metal coating initially laid on the steel strip.

51. The device according to claim 39,
further comprising a command module; and
wherein at least one of said first and second magnetic members has at least one electromagnetic member with an induction coil whose magnetic capacity is adjustable by said command module controlling said induction coil encapsulating said electromagnetic member, such as to:
induce at least one electromotive field able to generate in counter-interaction to a forced running movement of the steel strip in the static magnetic field a wiping deceleration adapted to layers of metal coating initially laid on the steel strip; and
set an equal distance between each of said first and second magnetic members and the steel strip.

52. The device according to claim 51, further comprising a processing unit, said command module controlled by said processing unit and able to receive at least one of the following two signals in order to adjust a current setting in said induction coil:
a distance measurement signal from a contactless measurement system measuring the distance between the steel strip and one of said electromagnetic members; and
a magnetic field measurement signal from a field measurement instrument to at least one electromagnetic member pole, the field measurement signal being correlatable with distance values measured.

53. The device according to claim 42, wherein said external magnetic field guide is a ferromagnetic frame yoke forming a magnetic guide loop around a section of the steel strip.
